(19) United States
(12) Patent Application Publication
(10) Pub. No.: US 2002/0035203 A1
(43) Pub. Date: Mar. 21, 2002

(54) Unsaturated polyester resin modified with a viscous block copolymer for use in solid surface products

(76) Inventors: Michael G. Elliott, Albuquerque, NM (US); Sharon Jones Elliot, Albuquerque, NM (US)

Correspondence Address: Jenifer C. Slinskey, Esq., Thorp Reed & Armstrong, LLP, One Riverfront Center, Pittsburgh, PA, 15222, US

(21) Appl. No.: 09/777,413

(22) Filed: Feb. 6, 2001

Related U.S. Application Data
(60) Provisional application No. 60/181,319, filed on Feb. 9, 2000.

(51) Int. Cl. C08L 53/00

(52) U.S. Cl. 525/88

(57) ABSTRACT

An unsaturated polyester solid surface material comprising in a weight to weight percent ratio, from 0.05% to 5.0% unsaturated polyester resin and a viscous block copolymer. This material exhibits improved mechanical properties such as tensile strength and flexibility as well as improved fabrication properties.

This application claims the benefit under 35 U.S.C. § 119(e) of the co-pending provisional application of Ser. No. 60/181,319 entitled “Unsaturated Polyester Resin Modified With A Viscous Block Copolymer For Use In Solid Surface Products” filed on Feb. 9, 2000, which is incorporated herein by reference.

### TECHNICAL FIELD

The present invention relates to unsaturated polyester solid surface materials. Specifically, the present invention relates to a solid surface material comprising unsaturated polyester resin and viscous block copolymers whereby the polyester solid surface material exhibits improved tensile strength, flexural properties, and improved fabrication and tooling and handling behavior.

### BACKGROUND OF THE INVENTION

Typically solid surface materials are comprised of either acrylic polymers or unsaturated polyesters in both the filler (or particulate or chip) and matrix phase of the product. These solid surface materials also typically contain organic or inorganic fillers. Fillers are generally less expensive than resins and therefore the addition of fillers may reduce the overall raw material costs for the solid surface product. Further, fillers oftentimes enhance mechanical and aesthetic properties of the solid surface materials.

Due to the soft nature of acrylic resins used for solid surfaces, high levels of fillers, typically the mineral filler alumina trihydrate, (“ATH”) must be added. If such a filler were not added, the acrylic solid surface material would melt easily and would be unworkable (sanding, cutting, drilling, etc.)

Unsaturated polyester resin products, however, can have workability with or without filler. Therefore, the amount of filler to use with unsaturated polyester depends on the application and the aesthetics of the solid surface product desired, as well as the desired overall cost of the product.

Historically, solid surface products comprised of unsaturated polyester have exhibited inferior performance to those made from acrylic polymers. This is particularly evident in flexural strength, cracking, chipping, handling, sanding, cutting and routing of the final product. Further, the handling properties of unsaturated polyester products diminish with the increase of unsaturated polyester resin in the matrix and with increases in particulate (filler) size.

Unsaturated polyester resin systems crosslinked with styrene are typically considered to be strong and rigid materials, at least on a small scale. When these materials are cast into a very large sheet (3′×10′) with a limited thickness (0.5″), then the mechanical limitations (such as brittleness, warpage, susceptibility to cracking and chipping) of such materials become very apparent.

Filling the unsaturated polyester matrix with ATH is one way to strengthen these systems. ATH acts as a self-extinguisher and therefore the greater the amount of ATH in a product, the more resistant the product is to burning. The National Fire Protection Association (“NFPA”) assigns NFPA ratings or building code ratings to products and materials depending on their rate of burn. Class I materials burn the least. Class III materials have the most rate of burn (these are the opposite of Class I). The typical Class I materials referred to herein contain approximately 51% ATH, while the typical Class III materials referred to herein contain approximately 1-15% ATH. The Class III products are herein referred to as either typical Class III or typical Class III textured solids. The materials referred to as typical Class III use a larger chip particulate than typical Class III textured solids. That is, typical Class III's tend to have more particulate in the ⅜-inch size in diameter. The materials referred to as typical Class II textured solids use a smaller chip particulate than typical Class III's, and tend to have more particulate of size less than ¼ inch in diameter.

Class I solid surface products can show an improvement of up to 100% in mechanical properties as a result of filling with ATH. On the negative side, filling unsaturated polyester resin with ATH leads to an increase in the production of fines when the product is made into chip (particulate) or fabricated. The term “fines” refers to the dust or the smallest particles that are produced when polyester is ground to make the particulate. These fines which are prone to being lost in the grinding process, are difficult to handle and lead to a loss of clarity and definition in the finished sheetstock as well as higher product cost through raw material loss.

One prior art method to modify the mechanical performance of polyester solid surface sheetstock is to vary the composition of the base polyester resin and the crosslinking agents. Chemical modification of the basic resin system is a good way to make solid surface products more flexible and with higher tensile strength. For example, varying the composition of polyester solutions with adipic acid or diethylene glycol tends to soften the resultant casting, however this also results in the loss of mechanical properties such as tensile and flexural strength. Further, changes to the basic resin composition are not a very efficient way to control fracture behavior or to alter fabrication performance as the trade-off is usually a loss of hardness, heat distortion temperature and rigidity in the cast sheet.

Therefore, there is a need in the art for a solid surface polyester material with improved mechanical properties such as tensile strength, flexibility, resistance to cracking and chipping, improved handling, sanding, cutting and routing capabilities.

### SUMMARY OF THE INVENTION

The present invention provides for improvements in the mechanical properties such as tensile strength and flexibility of unsaturated polyester solid surface materials through the addition of rubber-like materials (polyolefinic in nature) that will disperse into the unsaturated polyester matrix as a second phase microdispersion (discontinuous phase) to act as a “shock absorbing” phase to mediate and inhibit fracture propagation. Because the rubber-like materials (polyolefinic in nature) are added in very small amounts, they typically will not compromise the overall strength of the continuous unsaturated polyester matrix. One disadvantage to adding a microdispersed phase to the unsaturated polyester resin is clouding of the overall solid surface product and loss of clarity. However, this is controllable by the amount and nature of rubber added.

### DETAILED DESCRIPTION OF THE INVENTION

One of the problems to be solved with in attempting to add a polyolefin to an uncured unsaturated polyester resin is to find a way to disperse the polyolefin throughout the resin. Most polyolefins are solid materials and therefore need to be dissolved in the polystyrene matrix or, at best, need to be finely divided so as to provide a smooth dispersion. Not many materials fit these requirements. A number of different polyolefins have been tested with the following results.

It was determined that polystyrene, in the form of a foam, can be dissolved into the unsaturated polyester resin. Further, if the dissolved polystyrene is loaded to less than 3% by unsaturated polyester resin weight, the polystyrene will remain dispersed upon curing. Unfortunately, polystyrene does not help the mechanical performance of the cured resin. That is, the addition of polystyrene to the unsaturated polyester resin does not result in an unsaturated polyester solid surface product with improved tensile strength and flexural properties.

Additionally, it was determined that polyethylene in a solid form was not soluble in the resin solution but would swell slightly from the absorption of styrene. Therefore, polyethylene was not further tested as a possible additive to the unsaturated polyester resin to produce a solid surface product with improved mechanical properties.

Rubber cement was looked at as an inexpensive and readily available way to solve the solubility issue. Rubber cement provides a way to add to the unsaturated polyester resin a low molecular weight polyolefin that is already in solution. It was determined that the polyester matrix would accept at least a 1% by resin weight loading of rubber cement before the rubber would bloom on the surface of the sheet upon curing. The term “bloom” is a term used in the art and it generally refers to signs of incompatibility, generally described as a haze or lack of clarity on the surface of the cured sheet. Rubber cement did reduce the amount of fines formed from grinding the sheet. Use of rubber cement also resulted in a slight improvement of the mechanical properties of the sheet.

These preliminary tests showed that the unsaturated polyester system would indeed tolerate the addition of small amounts of polyolefin, that the polyolefin was capable of being microdispersed in the unsaturated polyester matrix and that the microdispersed polyolefin was able to alter the fracture performance of the resin.

Next, viscous block copolymers were tested to determine their effectiveness as modifiers to unsaturated polyester resins in producing solid surface products with improved mechanical properties. The term “viscous block copolymer” herein means any one of the following four formulae:

(1) A viscous block copolymer of the formula

A—B

wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers, and wherein the A blocks have a greater number of di-, tri- and tetra-substituted unsaturation sites per unit of block mass than do the B blocks and wherein the A blocks have a weight average molecular weight from about 100 to about 3000 and the B blocks have a weight average molecular weight from about 1000 to about 15,000.

(2) A viscous block copolymer of the formula

(A—B—A)ₙ—Yᵣ—(A_{q}—B)ₘ

wherein Y is a coupling agent or coupling monomers and wherein A and B are polymer blocks which may be homopolymer blocks of conjugated diolefin monomers, copolymer blocks of conjugated diolefin monomers or copolymer blocks of conjugated diolefin monomers and monoalkenyl aromatic hydrocarbon monomers, and wherein the A blocks have a greater number of tertiary unsaturation (TU) sites per unit of block mass than do the B blocks, and wherein the A blocks have a molecular weight from 100 to 300 and the B blocks have a molecular weight from 1000 to 15,000, and wherein p and q are 0 or 1 and n.0, r is 0 or 1, m>/=0 and n+m ranges from 1 to 100; and wherein the copolymer is epoxidized such that 0.1 to 3 Meq/g of epoxide is present.

(3) A viscous block copolymer of the formula

(A—B—Aₚ)ₙ—Yᵣ—(A_{q}—B)ₘ

wherein Y is a coupling agent, coupling monomers or an initiator, and wherein A is a polymer block which is a homopolymer block of conjugated diolefin monomer, a copolymer block of conjugated diolefin monomers or a copolymer block of conjugated diolefin monomers and monoalkenyl aromatic hydrocarbon monomers, and wherein B is a polymer block which is a homopolymer or copolymer block of monoalkenyl aromatic hydrocarbon monomer(s) or a copolymer block of monoalkenyl aromatic hydrocarbon monomer(s) and a minor amount of a conjugated diene, and wherein the A blocks have a greater number of di-, tri-, and tetra-substituted epoxides per unit of block mass than do the B blocks, and wherein the A blocks have a molecular weight from about 100 to about 3000 and the B blocks have a molecular weight from about 1000 to about 15,000, and wherein p and q are 0 or 1 and n>0, r is 0 or 1, m>/=0 and n+m ranges from 1 to 100; and wherein the copolymer is epoxidized such that 0.1 to 3 Meq/g of epoxide is present.

(4) A viscous block copolymer of the formula

(A—B—Aₚ)ₙ—Yᵣ—(A_{q}—B)ₘ

wherein Y is a coupling agent, coupling monomers or an initiator, and wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers, and wherein the A blocks have a greater number of di-, tri-, and tetra-substituted epoxides per unit of block mass than do the B blocks, and wherein the A blocks have a peak molecular weight as measured by gel permeation chromatography from 100 to 3000 and the B blocks have a peak molecular weight as measured by gel permeation chromatography from 1000 to 15,000, and wherein p and q are 0 to 1 and n>0, r is 0 or 1, m>/=0 and n+m ranges from 1 to 100; and wherein the copolymer is epoxidized such that 0.1 to 3 Meq/g of epoxide is present.

Variations of these formulae and illustrative examples may be found in U.S. Pat. No. 5,229,464, U.S. Pat. No. 5,399,626, U.S. Pat. No. 5,449,718, and U.S. Pat. No. 5,686,535, which patents are herein incorporated by reference.

Unsaturated Polyester Resin Solid Surface Product Modified with KRATON® D1118 and L-207:

KRATON® D1118 (“D1118”), available from Shell Chemical Company (1-800-4-KRATON) in granular form, is a solid SBS rubber which was chosen as a potential rubber modifier for unsaturated polyester resin. As stated on the website www.kraton.com, D 1118 “is a block copolymer with polystyrene end blocks and a rubbery polybutadiene mid block. This S-B-S polymer (20% S-B-S triblock, 80% S-B diblock) was developed to provide a low modulus, low cohesive strength, soft rubber.

PROPERTIES OF D1118

| | |
|---|---|
| Polymer: SBS | Polystyrene content in % mass: 31 |
| Type: Radical | Total Extractables in % mass: |
| | Hardness, Shore A, 30s: 61 |

D1118 is also a type of viscous block copolymer. As the unsaturated polyester resin contains styrene, it was hypothesized that D1118 would be readily compatible with the resin upon dissolving (as D1118 contains styrene endblocks). It was hypothesized that the styrene endblocks would allow the rubber to dissolve into the resin as was previously shown to occur with polystyrene. Unfortunately, the D1118 granules did nothing more than swell in the resin. High shear mixing and extended swell times did not improve the dispersion.

Next, D1118 was dissolved 1:4 weight to weight (“w:w”) in mineral spirits. Mineral spirits, paint thinner or oil of mineral spirits alternatively may be used as the diluent. The dissolved D1118 was then dissolved into an equal volume of a typical Class III unsaturated polyester resin and then blended into the final product mix. The D1118 rubber had a tendency to settle out of solution and constant stirring was required to maintain adequate dispersion of the D1118 in the premix. Samples of D1118 were formulated into a typical Class III unsaturated polyester resin at a 1% w:w loading [D1118 in particulate (or filler or chip) and D1118 in both particulate and matrix.] The results are summarized in Table 1.

TABLE 1
Typical Class III Solid Surface
Product Modified with KRATON ® D1118

| | | | Typical Class III |
|---|---|---|---|
| | | Typical Class III | Solid Surface |
| | Typical Class III | Solid Surface | Product comprised |
| | Solid Surface | Product comprised | of 1% D1118 in |
| | Product (without | of 1% D1118 in | chip and 1% D1118 |
| Property | any D1118) | chip | in matrix |
| Hardness | 45 | 40 | 35-40 |
| Tensile | 1760 PSI | 2540 PSI | 2240 PSI |
| Strength | | | |
| Tensile | 0.30% | 1.07% | 1.10% |
| Elong. | | | |
| Flex | 110 PSI | 135 PSI | 135 PSI |
| Strength | | | |
| Flex | 4.75% | 7.13% | 10.1% |
| Elong. | | | |
| Flex Load | 41.0 lb. | 49.3 lb. | 46.7 lb. |

Additional research was then performed using KRATON LIQUID®0 Polymer L-207 (“L-207”), a type of viscous block copolymer. Due to its functionality and the fact that it is a liquid, L-207 was investigated as a potentially more useful and more easily handled modifier than D1118, since D1118 must be made into a premix in mineral spirits before it may be adequately added to the unsaturated polyester resin.

According to the Technical Bulletin dated March 1998 by Shell Chemical Company, “L-207 is a hetero-telechelic polymer consisting of a primary hydroxyl functionality on one end of the polymer and expoxidized isoprene functionality on the other end.”

PROPERTIES OF L-207

| Property | Typical Value |
|---|---|
| Product form | 1Clear, viscous liquid |
| Specific gravity, g/cc @ 24° C. | 0.88 |
| Hydroxyl equivalent weight | 6.600 |
| Epoxy equivalent weight | 590 |
| +TL,4/16 Neat polymer viscosity, cps | |
| @30° C. | 46,000 |
| @50° C. | 11,000 |
| @70° C. | 4,000 |
| @100° C. | 1,200 |

L-207, is an ethylene/butadiene liquid rubber with epoxide functionality on one end and hydroxy functionality on the other. L-207 is Poly (epoxidized isoprene/ethylene/propylene) Poly (ethylene/butylene). Materials such as L-207 are generally chosen by formulators of adhesives to give the adhesive better stretch before breaking because the endgroup functionality makes it possible for these materials to microdisperse and chemically react into certain systems. While a large extent of reaction was not expected, some reaction with the unsaturated polyester resin system was expected. It was further hypothesized that the polar endgroups would allow for easy dispersion into the polyester matrix while the hydrocarbon chains would enable microdroplets to form.

Upon testing, the L-207 was easily dispersed into the resin by simple mixing. At least 0.5% w:w of L-207 could be added into the unsaturated polyester resin without any sign of blooming. Further, even at 1% w:w, no real decrease in hardness of the resultant polyester solid surface product was observed. However, clouding of the polyester matrix was evident upon addition of the L-207, even at an L-207 loading of as low as 0.25% w:w. The addition of L-207 did not affect the degree of cure or cure time and it did not adversely affect the UV stability of the cured resin.

Further, samples of unsaturated polyester solid surface materials were made and tested using L-207 in the particulate and/or in the matrix. Loadings of 0.5% and 0.25% w:w were tested. The results are summarized in Tables 2 and 3. Samples containing 1% L-207 were not prepared at this loading as the cured material tended to become too opaque and show some tendency to bloom a small amount of rubber on the surface of the plaques.

TABLE 2
Typical Class III Solid Surface Product Modified with
KRATON LIQUID ® L-207 in Chip

| | | | Typical Class III |
|---|---|---|---|
| | Typical Class III | Typical Class III | Solid Surface |
| | Solid Surface | Solid Surface | Product comprised |
| | Product | Product comprised | of 0.5% L-207 |
| | comprised | of 0.5% L-207 | Repeat |
| Property | of 0.25% L-207 | (6″ × 6″) | (1′ × 3′) |
| Hardness | 45 | 45 | 45 |
| Tensile | 1788 PSI | 2662 PSI | 2463 PSI |
| Strength | | | |
| Tensile | 0.62% | 0.91% | 0.77% |
| Elong. | | | |
| Flex | 116 PSI | 173 PSI | 155 PSI |
| Strength | | | |
| Flex | 6.54% | 7.13% | 8.91% |
| Elong. | | | |
| Flex Load | 43.7 lb. | 68.3 lb. | 55.7 lb. |

TABLE 3
Typical Class Ill Solid Surface Product Modified with
KRATON LIQUID ® L-207 in Chip and Matrix

| | Typical Class III | Typical Class III |
|---|---|---|
| | Solid Surface | Solid Surface |
| | Product comprised | Product comprised |
| | of 0.25% L-207 in | of 0.5% L-207 in |
| | matrix | matrix |
| | and 0.25% L-207 in | and 0.5% L-207 in |
| Property | % chip | chip |
| Hardness | 45 | 45 |
| Tensile Strength | 1928 PSI | 2626 PSI |
| Tensile Elong. | 0.62% | 0.61% |
| Flex Strength | 128 PSI | 152 PSI |
| Flex Elong. | 7.13% | 7.72% |
| Flex Load | 46.3 lb. | 56.71b. |

As shown in Table 2, L-207 in the particulate or chip or filler phase seems to provide more improvement in mechanical properties than in the filler and matrix combined. Further, as shown in Tables 1 and 2, the maximum benefit of adding either D1118 or L-207 appeared to be at the 0.5% w/w level, because the addition of 0.25% L-207 showed almost no improvement over that of unmodified sheet, and at 1% D1118, the improvement is less than that of 0.5%.

Based on the results obtained in Tables 2 and 3, samples of a Typical Class I material using a 0.5% loading of L-207 in the particulate and in the particulate and matrix were also prepared and evaluated. The results are summarized in Table 4.

TABLE 4
Typical Class I Solid Surface Product Modified with Kraton L-207 in Chip
and Matrix

| | Typical Class I | Typical Class I | |
|---|---|---|---|
| | Solid Surface | Solid Surface | |
| | Product comprising | Product comprising | |
| | 0.0% L-207 in | 0.5% L-207 in | Production |
| | matrix | matrix | Typical |
| | 0.5% L-207 in % | and 0.5% L-207 in | Class I Solid |
| Property | chip | chip | Surface Product |
| Hardness | 50-55 | 50-55 | 50-55 |
| Tensile | 3517 PSI | 3370 PSI | 3367 |
| Strength | | | |
| Tensile | 1.06% | 1.22% | 0.45% |
| Elong. | | | |
| Flex | 246 PSI | 251 PSI | 2.60 PSI |
| Strength | | | |
| Flex | 8.32% | 7.13% | 5.94% |
| Elong. | | | |
| Flex Load | 88.7 lb. | 92.3 lb. | 94.0 lb. |

As previously shown in Table 1 and herein confirmed in Table 4, D1118 or L-207 in the particulate phase seems to provide more improvement in mechanical properties than in the filler and matrix combined.

As shown in Tables 1-4, the addition of a viscous copolymer, such as D1118 or L-207 (either liquid or solid) to unsaturated polyester resin provides dramatic improvement in mechanical properties of the cured sheet or solid surface product.

The typical Class III material shows an increase of 30% to 50% in mechanical properties upon addition of 0.5% L-207 in the particulate. This product also shows less chipping and dusting when tooled than products that do not contain either D1118 or L-207.

While the typical Class I material does not show as dramatic an improvement in mechanical properties with 0.5% L-207 added to the particulate, there is a reduction in dusting upon tooling this modified material (routing of this material produces a large percentage of shavings as well as fines).

Additional tests were conducted with sheetstock which is a cured, cast polyester resin. As shown below in Graph 1, this material was modified with 0.5% w/w L-207 and was put through a lab grinder. The results were that very little dust was produced, even in a Class 1 material. Sieve analysis verifies that 83% of the grind is of screen size 10-50 with the maximum population (51%) at screen 20.

In contrast, as shown below in Graph 2, analysis of this same sheetstock material (unmodified) made and ground by production shows sizeable amounts of particulate in the range of sieves 20-120. For example, as shown on Graph 1, the material modified with 0.5% L-207 had 3.6% pan waste or fines, while the same material that was not modified with L-207 has 16.7% pan waste or fines.

Unsaturated Polyester Resin Solid Surface Product Modified with KRATON® L-1203 and L-1302:

Although L-207 provided the desired performance (mechanical and fabricating), this material involves a two step reaction procedure (first the anionic polymerization of ethylene/butylene followed by the epoxidation of the remaining butylene endgroups). Therefore, more cost-effective alternatives were evaluated, including a simple hydroxy terminated ethylene/butylene (L-1203) and the pre-epoxidized version of L-207 (L- 1302).

As stated in data document issued November 2000 by Kraton Polymers entitled “Kraton™ L-1203 Liquid Polymer,” L-1203 “is a polymeric diol which contains one aliphatic, primary hydroxyl group located on the terminal end of a poly(ethylene/butylene) elastomer. The primary hydroxyl group reacts rapidly and allows for cross-linking and chain extension. The anionically polymerized, amorphous, saturated hydrocarbon backbone affords good polymer stability and durability to weathering, hydrolysis, thermo-oxidative degradation and acid/base and polar solvent attack.”

PROPERTIES OF L-1203

| | | | | | |
|---|---|---|---|---|---|
| | Physical | Test | | Typical | Sales Specification |
| Property | Form | Method | Units | Value | (where applicable) |

| | | | | |
|---|---|---|---|---|
| Polystyrene content | BAM 919 | % w | 0 | — |
| Approximate functionality | | | 0.9 | — |
| Hydroxyl equivalent weight | | | 4,200 | — |
| Neat polymer viscosity at 25° C. | | cps | 22,000 | — |
| Solution Viscosity^{a} | BAM 922 | cps | 120 | 50-120 |
| Color, APHA | | Pt-Co | | <800 |
| Water | | ppmw | | <75 |
| Specific gravity | BAM 1014 | | 0.88 | — |

(a) Measured on 60% w solution in toluene at 25° C. using a Brookfield viscometer, LTF or LTV model
(b) Measured on compression molded slabs
(c) Measured on films cast from a solution in toluene

As stated in data document issued November 2000 by Kraton Polymers entitled “Kraton™ L-1302 Liquid Polymer,” L-1302 “is a hetrero-telechelic polymer consisting of a primary hydroxyl functionality on one end of the polymer and a polyisoprene functionality on the other end.

PROPERTIES OF L-1302

| | | | | | |
|---|---|---|---|---|---|
| | Physical | Test | | Typical | Sales Specification |
| Property | Form | Method | Units | Value | (where applicable) |

| | | | | |
|---|---|---|---|---|
| Polystyrene content | BAM 919 | % w | 0 | — |
| Hydroxyl equivalent weight | | | 6,000 | — |
| Double bond equivalent weight | | | 590 | — |
| Neat polymer viscosity at 25° C. | | cps | 50,000 | — |
| Solution Viscositya | BAM 922 | cps | 2,000 | — |
| Color, APHA | | Gardner | — | <300 |
| Water | | ppmw | | <10,000 |
| Specific gravity | BAM 1014 | | 0.89 | — |

(a) Measured on 80% w solution in toluene at 25° C. using a Brookfield viscometer, LTF or LTV model
(b) Measured on compression molded slabs
(c) Measured on films cast from a solution in toluene

L-1203 and L-1302 are also types of viscous block copolymers. Table 5 summarizes the results of an unsaturated polyester resin solid surface product prepared with either (1) a 0.5% w:w of L-1203, (2) a 0.5% w:w of L-1302 and (3) a 0.75% w:w of L-1302. These conditions as well as the amount of loading were based on previous work with L-207.

TABLE 5
Typical Class III Solid Surface Product Modified with
KRATON ® L-1203 and L-1302

| | | | Typical Class III |
|---|---|---|---|
| | Typical Class III | Typical Class III | Solid Surface |
| | Solid Surface | Solid Surface | Product |
| | Product comprising | Product comprising | comprising |
| | 0.5% L-1203 | 0.5% L-1302 | 0.75% L-1302 |
| Property | in chip | in chip | in chip |
| Hardness | 45 | 45 | 45 |
| Tensile | 1944 PSI | 2119 PSI | 2070 PSI |
| Strength | | | |
| Tensile | 0.15% | 1.23% | 0.93% |
| Elong. | | | |
| Flex | 122 PSI | 128 PSI | 127 PSI |
| Strength | | | |
| Flex | 7.13% | 7.13% | 7.13% |
| Elong. | | | |
| Flex Load | 47.0 lb. | 45.71b. | 45.3 lb. |

As shown in Table 5, the L-1203 seems to have little or no effect on the mechanical properties of the typical Class III unsaturated polyester solid surface product. Further, when 0.5% of L-1302 was used, some improvement was seen in mechanical properties but not to the extent of the unsaturated polyester solid surface product comprising L-207.

Therefore, further tests were conducted to determine whether a higher loading (0.75%) of the L-1302 would add more strength to the unsaturated polyester solid surface product. As shown in Table 5, higher loading of L-1302 proved to offer no additional benefits to the mechanical properties of the solid surface product. This result was consistent with that previously seen in Table 2, with the additional higher loading of L-207 which did not result in improved mechanical properties over the 0.5% loading of L-207.

All of the unsaturated polyester solid surface materials modified by either L-1203 or L-1302 showed less chipping or cracking with tooling; less dusting; and better control of particulate size upon grinding. In other words, they performed like their L-207 counterparts in tooling and handling but to a lesser extent.

Therefore, as shown from the results included in Tables 1-5, the addition of a viscous block copolymer (solid or liquid of any kind) to unsaturated polyester resin improves the mechanical properties (such as tensile strength and flexible strength) of the resultant unsaturated polyester solid surface product over unsaturated polyester solid surface materials that are not modified with a viscous block copolymer. This improvement may be by as much as 50-60%. The improvement in mechanical properties is greatest at 0.5% by resin weight and by adding the viscous block copolymer to the particulate rather than to the matrix and/or particulate. At percentages greater than 0.5%, the mechanical property improvement begins to diminish. It was determined that of the materials tested, L-207 provides the most pronounced improvement.

Further, as shown in Graphs 1-2, the addition of a viscous block copolymer (solid or liquid) alters the particle distribution of particulate when the sheet stock is ground. Fewer fines are produced, dusting is minimal and the majority of particulate is at or near the target size. In other words, the grind becomes very regular in size and the fines and/or dust represent a minimal fraction of the mix. This is true for both Class I and Class III. Class III products do not contain a very large amount of ATH. As a result, the appearance of the finished sheet is somewhat altered. For example, the viscous block copolymer modified typical Class I material shows a bolder and more pronounced pattern with fewer fines to cloud and “pigment” the underlying matrix.

Additionally, sheetstock that has been modified with a viscous block copolymer (solid or liquid) in the particulate and/or in the matrix fabricates differently as well. The material shows a reduced tendency to chip when sawed or routed, routing tends to produce shavings rather than dust and upon sanding, the dust that is produced tends to clump as opposed to becoming airborne.

While not all of the unsaturated polyester solid surface products modified with the viscous block copolymer showed significant improvements in the resulting mechanical properties, all of the unsaturated polyester solid surface products modified with the viscous block copolymer showed improved fabricating properties. That is, they are much less prone to chipping or cracking when cut or routed, they produce minimal dust when routed (shavings are more common) and they produce less fly-away dust when sanded.

Typical Class III (textured solid) Solid Surface Product Modified with L-207:

A typical Class III textured solid surface material was modified with L-207. Lab pours/autoclave cures of 0.5% L-207/typical Class III textured solid particulate were made and ground. Samples were prepared of the typical Class III textured solid, regular particulate; L-207/typical Class III textured solid particulate (lab grind); L-207/typical Class III textured solid particulate (commercial grind); L-207/typical Class III textured solid particulate and L-207 in matrix. This data is summarized in Table 6.

TABLE 6
Typical Class III (textured solid) Solid Surface Product Modified with L-207

| | | | Typical Class | Typical Class |
|---|---|---|---|---|
| | | | III (textured | III (textured |
| | | Typical Class III | solid) Solid | solid) Solid |
| | | (textured solid) | Surface | Surface |
| | | Solid Surface | Product | Product |
| | Typical Class | Product | comprised of | comprised of |
| | III (textured | comprised of | 0.5% L-207 | 0.5% L-207 |
| | solid) Solid | 0.5% L-207 | in SG chip | in chip |
| | Surface | in SG chip | (lab grind) | (PARTCO |
| Property | Product | (lab grind) | and matrix | grind) |
| Hardness | 45 | 45 | 45 | 45 |
| Tensile Strength | 1937 PSI | 1932 PSI | 1784 PSI | 2153 PSI |
| Tensile Elong. | 0.46% | 0.46% | 0.46% | 0.46% |
| Flex Strength | 112 PSI | 131 PSI | 114 PSI | 145 PSI |
| Flex Elong. | 5.35% | 7.13% | 5.35% | 6.54% |
| Flex Load | 10.3% | 46.3 lb. | 40.3 lb. | 53.7 lb. |

Therefore, it can be determined that hetero-telechelic polymers and epoxidized isoprene polymers are useful in modifying mechanical and handling properties of solid surface materials. A viscous block copolymer in the filler phase (particulate) provides greater improvement in mechanical properties in solid surface materials than in the filler and matrix phases combined. Further, levels of the viscous block copolymer from 0.25% to 1.0% based on weight of resin are particularly useful in providing unsaturated polyester solid surface products with improved mechanical and/or fabricating properties.

Additionally, sheetstock materials with additions of 0.5% of the viscous block copolymer typically exhibit mechanical property improvements of 30 to 60 percent.

Viscous block copolymer modified solid surface products also exhibit less chipping, and have reduced dusting when cut, sanded or routed. These unsaturated polyester resins modified with viscous block copolymer particulate exhibit improved clarity and sharpness of filler images when incorporated into solid surface materials. Further particulate ground with a viscous block copolymer modification exhibit less dust and fines. Particulate modified with a viscous block copolymer has improved economics because of reduced raw material waste.

Further, environmentally, viscous block copolymer modified products are safer due to reduced airborne dust.

What is claimed is:

1. A composition comprising unsaturated polyester resin and a viscous block copolymer in a weight to weight percent ratio of from 0.05% to 5.0%.

2. The composition of claim 1 wherein the viscous block copolymer is of the formula
A—B
wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of di-, tri- and tetra-substituted unsaturation sites per unit of block mass than do the B blocks; and
wherein the A blocks have a weight average molecular weight from about 100 to about 3000 and the B blocks have a weight average molecular weight from about 1000 to about 15,000.

3. The composition of claim 1 wherein the viscous block copolymer is of the formula
(A—B—A)ₙ—Yᵣ—(A_{q}—B)ₘ
wherein Y is a coupling agent or coupling monomers; and
wherein A and B are polymer blocks which may be homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of tertiary unsaturation (TU) sites per unit of block mass than do the B blocks; and
wherein the A blocks have a molecular weight from 100 to 300 and the B blocks have a molecular weight from 1000 to 15,000; and
wherein p and q are 0 or 1 and n.0, r is 0 or 1, m>/=0 and n+m ranges from 1 to 100; and
wherein the copolymer is epoxidized such that 0.1 to 3 Meq/g of epoxide is present.

4. The composition of claim 1 wherein the viscous block copolymer is of the formula
(A—B—Aₚ)ₙ—Yᵣ—(A_{q}—B)ₘ
wherein Y is a coupling agent, coupling monomers or an initiator; and
wherein A is a polymer block which is a homopolymer block of conjugated diolefin monomer, a copolymer block of conjugated diolefin monomers or a copolymer block of conjugated diolefin monomers and monoalkenyl aromatic hydrocarbon monomers; and
wherein B is a polymer block which is a homopolymer or copolymer block of monoalkenyl aromatic hydrocarbon monomer(s) or a copolymer block of monoalkenyl aromatic hydrocarbon monomer(s) and a minor amount of a conjugated diene; and
wherein the A blocks have a greater number of di-, tri-, and tetra-substituted epoxides per unit of block mass than do the B blocks; and
wherein the A blocks have a molecular weight from about 100 to about 3000 and the B blocks have a molecular weight from about 1000 to about 15,000; and wherein p and q are 0 or 1 and n>0, r is 0 or 1, m>/=0 and n+m ranges from 1 to 100; and wherein the copolymer is epoxidized such that 0. 1 to 3 Meq/g of epoxide is present.

5. The composition of claim 1 wherein the viscous block copolymer is of the formula
(A—B—Aₚ)ₙ—Yᵣ—(A_{q}—B)_{m,}
wherein Y is a coupling agent, coupling monomers or an initiator; and
wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of di-, tri-, and tetra-substituted epoxides per unit of block mass than do the B blocks; and
wherein the A blocks have a peak molecular weight as measured by gel permeation chromatography from 100 to 3000 and the B blocks have a peak molecular weight as measured by gel permeation chromatography from 1000 to 15,000; and
wherein p and q are 0 to 1 and n>0, r is 0 or 1, m>/=0 and n+m ranges from 1 to 100; and
wherein the copolymer is epoxidized such that 0.1 to 3 Meq/g of epoxide is present.

6. A solid surface material comprising unsaturated polyester resin and a viscous block copolymer in a weight to weight percent ratio of from 0.05% to 5.0%

7. The solid surface material of claim 6 wherein the viscous block copolymer is of the formula
A—B
wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of di-, tri- and tetra-substituted unsaturation sites per unit of block mass than do the B blocks; and
wherein the A blocks have a weight average molecular weight from about 100 to about 3000 and the B blocks have a weight average molecular weight from about 1000 to about 15,000.

8. The solid surface material of claim 6 wherein the viscous block copolymer is of the formula
(A—B—A)ₙ—Yᵣ—(A_{q}—B)ₘ
wherein Y is a coupling agent or coupling monomers; and
wherein A and B are polymer blocks which may be homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of tertiary unsaturation (TU) sites per unit of block mass than do the B blocks; and
wherein the A blocks have a molecular weight from 100 to 300 and the B blocks have a molecular weight from 1000 to 15,000; and
wherein p and q are 0 or 1 and n.0, r is 0 or 1, m>/=0 and n+m ranges from 1 to 100; and
wherein the copolymer is epoxidized such that 0.1 to 3 Meq/g of epoxide is present.

9. The solid surface material of claim 6 wherein the viscous block copolymer is of the formula
(A—B—Aₚ)ₙ——Yᵣ—(A_{q}—B)ₘ
wherein Y is a coupling agent, coupling monomers or an initiator; and
wherein A is a polymer block which is a homopolymer block of conjugated diolefin monomer, a copolymer block of conjugated diolefin monomers or a copolymer block of conjugated diolefin monomers and monoalkenyl aromatic hydrocarbon monomers; and
wherein B is a polymer block which is a homopolymer or copolymer block of monoalkenyl aromatic hydrocarbon monomer(s) or a copolymer block of monoalkenyl aromatic hydrocarbon monomer(s) and a minor amount of a conjugated diene; and
wherein the A blocks have a greater number of di-, tri-, and tetra-substituted epoxides per unit of block mass than do the B blocks; and
wherein the A blocks have a molecular weight from about 100 to about 3000 and the B blocks have a molecular weight from about 1000 to about 15,000; and wherein p and q are 0 or 1 and n>0, r is 0 or 1, m>/=0 and n+m ranges from 1 to 100; and wherein the copolymer is epoxidized such that 0.1 to 3 Meq/g of epoxide is present.

10. The solid surface material of claim 6 wherein the viscous block copolymer is of the formula
(A—B—Aₚ)_{n—Y}ᵣ—(A_{q}—B)ₘ
wherein Y is a coupling agent, coupling monomers or an initiator; and
wherein A and B are polymer blocks which are homopolymer blocks of conjugated diolefin monomers, copolymer blocks of conjugated diolefin monomers or copolymer blocks of conjugated diolefin monomers and monoalkenyl aromatic hydrocarbon monomers; and
wherein the A blocks have a greater number of di-, tri-, and tetra-substituted epoxides per unit of block mass than do the B blocks; and
wherein the A blocks have a peak molecular weight as measured by gel permeation chromatography from 100 to 3000 and the B blocks have a peak molecular weight as measured by gel permeation chromatography from 1000 to 15,000; and
wherein p and q are 0 to 1 and n>0, r is 0 or 1, m>/=0 and n+m ranges from 1 to 100; and
wherein the copolymer is epoxidized such that 0.1 to 3 Meq/g of epoxide is present.

11. A solid surface material comprising an unsaturated polyester resin and a viscous block copolymer.

12. The solid surface material of claim 11 wherein the viscous block copolymer is a block copolymer with polystyrene end blocks and a rubbery polybutadiene mid block.

13. The solid surface material of claim 12 wherein the viscous block copolymer is an SBS polymer comprised of 20% SBS triblock and 80% SB diblock.

14. The solid surface material of claim 13 wherein the unsaturated polyester resin comprises styrene.

15. The solid surface material of claim 14 additionally comprising approximately 1- 15% alumina trihydrate.

16. The solid surface material of claim 15 wherein the unsaturated polyester resin and the viscous block copolymer are in a weight to weight percent ratio of from 0.05% to 5.0%.

17. The solid surface material of claim 11 wherein the viscous block copolymer is Poly(epoxidized isoprene/ethylene/propylene)Poly(ethylene/butylene).

18. The solid surface material of claim 17 additionally comprising approximately 1-15% alumina trihydrate.

19. The solid surface material of claim 18 further defined as having a particulate and a matrix.

20. The solid surface material of claim 18 wherein the particulate comprises approximately 1% of viscous block copoloymer.

21. The solid surface material of claim 20 further defined as having the following properties: Hardness: 40; tensile strength: 2540 PSI; Tensile elongation: 1.07%; Flex Strength: 135 PSI; Flex elongation: 4.75%; and Flex load: 41.0 lb.

22. The solid surface material of claim 20 wherein the matrix comprises approximately 1% of viscous block copolymer.

23. The solid surface material of claim 22 further defined as having the following properties: Hardness: 35-40; tensile strength: 2240 PSI; Tensile elongation: 1.10%; Flex Strength: 135 PSI; Flex elongation: 10.1%; and Flex load: 46.7 lb.

24. The solid surface material of claim 11 wherein the viscous block copolymer is a hetero-telechelic polymer consisting of a primary hydroxyl functionality on one end of the polymer and expoxidized isoprene functionality on the other end of the polymer.

25. The solid surface material of claim 24 wherein the viscous block copolymer is Poly(epoxidized isoprene/ethylene/propylene)Poly(ethylene/butylene).

26. The solid surface material of claim 25 additionally comprising approximately 1-15% alumina trihydrate.

27. The solid surface material of claim 26 wherein the unsaturated polyester resin and the viscous block copolymer are in a weight to weight percent ratio of from 0.05% to 5.0%.

28. The solid surface material of claim 26 further defined as having a particulate and a matrix.

29. The solid surface material of claim 28 wherein the particulate comprises approximately 0.25% of viscous block copoloymer and the matrix comprises approximately 0.25% of viscous block copolymer.

30. The solid surface material of claim 29 further defined as having the following properties: Hardness: 45; tensile strength: 1928 PSI; Tensile elongation: 0.62%; Flex Strength: 128 PSI; Flex elongation: 7.13%; and Flex load: 46.3 lb.

31. The solid surface material of claim 28 wherein the particulate comprises approximately 0.5% of viscous block copolymer.

32. The solid surface material of claim 31 further defined as having the following properties: Hardness: 45; tensile strength: 1932-2153 PSI; Tensile elongation: 0.46%; Flex Strength: 131-145 PSI; Flex elongation: 6.54-7.13%; and Flex load: 46.3-53.7 lb.

33. The solid surface material of claim 28 wherein the particulate comprises approximately 0.5% of viscous block copolymer and the matrix comprises approximately 0.5% of viscous block copolymer.

34. The solid surface material of claim 33 further defined as having the following properties: Hardness: 45; tensile strength: 1784-2626 PSI; Tensile elongation: 0.46-0.61%; Flex Strength: 114-152 PSI; Flex elongation: 5.35-7.72%; and Flex load: 40.3-56.7 lb.

35. The solid surface material of claim 25 additionally comprising approximately 51% alumina trihydrate.

36. The solid surface material of claim 35 wherein the unsaturated polyester resin and the viscous block copolymer are in a weight to weight percent ratio of from 0.05% to 5.0%.

37. The solid surface material of claim 35 further defined as having a particulate and a matrix.

38. The solid surface material of claim 37 wherein the particulate comprises approximately 0.5% of viscous block copoloymer.

39. The solid surface material of claim 38 further defined as having the following properties: Hardness: 50-55; tensile strength: 3517 PSI; Tensile elongation: 1.06%; Flex Strength: 246 PSI; Flex elongation: 8.32%; and Flex load: 88.7 lb.

40. The solid surface material of claim 37 wherein the particulate comprises approximately 0.5% of viscous block copolymer and the matrix comprises approximately 0.5% of viscous block copolymer.

41. The solid surface material of claim 40 further defined as having the following properties: Hardness: 50-55; tensile strength: 3370 PSI; Tensile elongation: 1.22%; Flex Strength: 251 PSI; Flex elongation: 7.13%; and Flex load: 92.3 lb.

42. The solid surface material of claim 11 wherein the viscous block copolymer is a polymeric diol which contains one aliphatic, primary hydroxyl group located on the terminal end of a poly(ethylene/butylene) elastomer.

43. The solid surface material of claim 42 additionally comprising approximately 1-15% alumina trihydrate.

44. The solid surface material of claim 43 wherein the unsaturated polyester resin and the viscous block copolymer are in a weight to weight percent ratio of from 0.05% to 5.0%.

45. The solid surface material of claim 43 further defined as having a particulate and a matrix.

46. The solid surface material of claim 45 wherein the particulate comprises approximately 0.5% of viscous block copolymer.

47. The solid surface material of claim 46 further defined as having the following properties: Hardness: 45; tensile strength: 1944 PSI; Tensile elongation: 0.15%; Flex Strength: 122 PSI; Flex elongation: 7.13%; and Flex load: 47.0 lb.

48. The solid surface material of claim 11 wherein the viscous block copolymer is a hetero-telechelic polymer consisting of a primary hydroxyl functionality on one end of the polymer and a polyisoprene functionality on the other end..

49. The solid surface material of claim 48 additionally comprising approximately 1-15% alumina trihydrate.

50. The solid surface material of claim 49 wherein the unsaturated polyester resin and the viscous block copolymer are in a weight to weight percent ratio of from 0.05% to 5.0%.

51. The solid surface material of claim 49 further defined as having a particulate and a matrix.

52. The solid surface material of claim 51 wherein the particulate comprises approximately 0.5% of viscous block copolymer.

53. The solid surface material of claim 52 further defined as having the following properties Hardness: 45; tensile strength: 2119 PSI; Tensile elongation: 1.23%; Flex Strength: 12 PSI; Flex elongation: 7.13%; and Flex load: 45.7 lb.

54. The solid surface material of claim 51 wherein the particulate comprises approximately 0.75% of viscous block copolymer.

55. The solid surface material of claim 54 further defined as having the following properties: Hardness: 45; tensile strength: 2070 PSI; Tensile elongation: 0.93%; Flex Strength: 127 PSI; Flex elongation: 7.13%; and Flex load: 45.3 lb.
